(19) United States
(12) Patent Application Publication
(10) Pub. No.: US 2022/0204717 A1
(43) Pub. Date: Jun. 30, 2022

(54) Encapsulated Reactive Components for Use in Activatable Materials

(71) Applicant: Zephyros, Inc., Romeo, MI (US)

(72) Inventors: David Kosal, Romeo, MI (US); Guillaume Klein, Molsheim Cedex (FR); Olivier Lemoine, Molsheim Cedex (FR)

(21) Appl. No.: 17/609,117

(22) PCT Filed: Jun. 3, 2020
(86) PCT No.: PCT/US2020/035954

§ 371 Date: Nov. 5, 2021

Related U.S. Application Data
(60) Provisional application No. 62/856,700, filed on Jun. 3, 2019.

(51) Int. Cl. C08J 9/16; C08J 3/24; C08J 9/00

(52) U.S. Cl. CPC C08J 9/16; C08J 3/241; C08J 9/009; C08J 9/0028; C08J 2203/22; C08J 2363/00; C08J 2323/06; C08J 2333/10; C08J 9/0033

(57) ABSTRACT

A material comprising an encapsulated component within a shell, a rupture initiator associated with the encapsulated component, and a polymeric matrix material, wherein the encapsulation is adapted to fail upon activation of the rupture initiator allowing the encapsulated component to be liberated to initiate a reaction or increase the reactivity of the material.

### FIELD OF THE INVENTION

The present teachings relate generally to reactive components that are encapsulated for use in activatable materials, and the manufacture and use of such materials.

### BACKGROUND OF THE INVENTION

Activatable materials such as adhesives, sealants, and reinforcing materials are commonly utilized in a variety of industries. When creating materials that undergo a transformation as a result of heat exposure or other stimulation (activatable materials), there is the possibility for these materials to prematurely react prior to use. The premature reaction occurs since the reactive components are intimately mixed with the reactant components, commonly referred to as a one-component material. The premature reaction results in an undesirable short shelf life. However, extending the shelf life of these “one-part” materials presents a number of obstacles.

In an effort to avoid such challenges, these activatable materials can be manufactured and stored as “two-part” compositions, so that the reactive components are separated from the reactant components. Often, such materials (when combined) react at room or ambient temperatures without the addition of heat or other additional stimulus. However, the manufacture, storage and eventual processing to combine such two-part materials can result in additional cost and effort.

In single component materials the curing agents and/or curing agent accelerators react slowly but are not typically inactive. Attempts have also been made to encapsulate portions of these materials to prevent premature curing of the single component materials. However, incomplete encapsulation, unwanted rupture of capsules during compounding or secondary processing and poor delivery of the reactive component to the remaining material has presented substantial challenges. The present invention, therefore, seeks to provide an improved activatable material including one or more encapsulated components for extending the shelf life of the material, or providing the ability to compound or form the formulations more aggressively during compounding.

### SUMMARY OF THE INVENTION

The teachings herein provide for a material comprising an encapsulated component within a shell, a rupture initiator associated with the encapsulated component, and a polymeric matrix material. The encapsulation is adapted to fail upon activation of the rupture initiator allowing the encapsulated component to be liberated to initiate a reaction or increase the reactivity of the material.

The teachings herein are further directed to a method for forming an industrial material comprising encapsulating an encapsulated component in an encapsulate shell, locating a rupture initiator within the encapsulate shell or within the shell surface, mixing the encapsulated component with a polymeric matrix material, and activating of the rupture initiator to allow the encapsulated component to be liberated to initiate a reaction or increase the reactivity of the material.

The failure of the shell may be initiated by having a rupturing component that is triggered by heat. The rupturing component can either be part of the polymeric shell of located inside of the shell with the reactive component.

The rupture initiator may be inside the shell with the encapsulated component. The rupture initiator may be formed as part of the shell surrounding the encapsulated component. The rupture initiator may comprise a foaming agent. The encapsulated component may comprise a plurality of particles to improve dispersion after liberation of the encapsulated component. The shell may comprise a polyester material. The rupture initiator may comprise a chemical or physical blowing agent. The encapsulated component may be selected from a curing agent, curing agent accelerator, foaming agent, foaming agent activator, moisture scavenger, acid, monomer, odor scavenger, or any combination thereof. The rupture initiator may activate in response to a stimulus. The rupture initiator may activate in response to a stimulus selected from pressure, heat, ultraviolet light, moisture, or any combination thereof.

The encapsulated component may be a curing agent. The encapsulated component may be a curing agent accelerator. The encapsulated component may be liquid at room temperature (20° C.-22° C.). The encapsulated component may be solid at room temperature (20° C.-22° C.). The encapsulated component may be dicyandiamide or a urea-based agent. The encapsulated component may be selected from amines, imidazoles, mercaptans, or combinations thereof. The encapsulated component may speed up a reaction of the material.

The shell may include polyester, gelatin, polyoxymethylene urea formaldehyde, melamine formaldehyde, polyurethane, silica, or some combination thereof. The shell may be formed by submerged nozzle extrusion, spinning disc coating, interfacial polymerization, microfluidics, coacervation, spray drying, fluidized bed coating, or some combination thereof. The shell may rupture when the rupture initiator expands from within the shell. The encapsulation may fail as a result of pressure on the shell surface, a chemical reaction with the shell surface or its contents, a stimulus affecting the shell surface or its contents, or some combination thereof.

The encapsulated component is a curing agent that causes the polymeric matrix to react at a temperature below 250° C., below 200° C., below 180° C., or even below 150° C. The material may be a thermoset material after cure. The material may be a thermoplastic material. The material may be a foamable material. The polymeric matrix material may be an epoxy-based material. The polymeric matrix material may comprise an ethylene material. The polymeric matrix material may comprise a methacrylate material. The polymeric matrix material may comprise a urethane-based material.

An encapsulation material may surround the encapsulated component and may be combined with a shell rupture initiator also inside the encapsulating shell. The rupture initiator may be capable of generating pressure to expose the reactive encapsulated material to the polymeric matrix material.

The teachings herein further provide for use of the materials described herein to seal a vehicle cavity. The teachings herein further provide for use of the materials described herein as a structural adhesive to adhere to two or more structural members together. The teachings herein envision of method of adhering and applying the material to a structural support member or cavity.

The materials and methods described herein allow for the use of encapsulated materials within a polymer matrix that include a rupture initiator to expose the encapsulated material to the polymeric matrix material.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description. Percentages herein refer to weight percent, unless otherwise indicated.

This application claims the benefit of the filing date of U.S. Provisional Application Ser. No. 62/856,700, filed on Jun. 3, 2019, the contents of that application being incorporated by reference herein for all purposes.

The latent reacting materials described herein are typically activated to react upon the exposure to a stimulus. However, it is also possible that no stimulus is required. Stimuli such as heat, moisture, pressure, ultraviolet light, or the like may be employed. It is recognized as a possible advantage if one or more of the reactive components of the material is maintained separate from one or more additional components in the polymeric matrix via encapsulation. In a single component material, the shell of the encapsulated reactive component may be caused to fail as a result of internal pressure created by the rupturing medium (e.g., rupture initiator). The preferred method is to have a rupture initiator that causes the shell to fracture thus delivering the reactive component to the polymeric matrix material. The rupture initiator can either be part of the polymeric encapsulant shell or located inside of the shell with the encapsulated component. Poor delivery of the active component has been a problem in the prior art. The rupture initiator provides a solution in that it allows the reactive component to be in closer proximity to the polymeric matrix material.

Typically, although not necessarily required, the polymeric matrix material is maintained separate from a reactive material, which may be a curing agent and/or curing agent accelerator by encapsulating the reactive material. Then, upon application of activation stimuli, a chemical reaction, or some combination thereof, the encapsulation will typically fail (e.g., rupture) thereby exposing the polymeric matrix material to the reactive material. In one specific embodiment, the curing agent accelerator may be encapsulated within the material (including the curing agent) and upon failure of the encapsulating surface, the curing agent accelerator is available to react with the curing agent in the polymeric matrix material.

Various types of encapsulating techniques may be employed for forming the desired encapsulated material. For example, and without limitation, techniques such as submerged nozzle extrusion, spinning disc coating, interfacial polymerization, microfluidics, coacervation, spray drying, fluidized bed coating, combinations thereof or the like may be utilized. Suitable methods for encapsulation are also disclosed in U.S. Application Publication No. 2018/0008948, incorporated by reference herein for all purposes. The particular technique used and the type of encapsulation formed can depend upon the material to be encapsulated and the state (e.g., liquid, solid, gas or combination thereof) of that material. Exemplary materials that form the encapsulation can include solid curing agents and/or curing agent accelerators and/or liquid curing agents and/or curing agent accelerators.

The rupturing of the encapsulant shell can be tailored by choosing various melting temperatures of the shell, by crosslinking the polymeric shell and by selecting different rupturing components.

Typically, to produce single component materials containing encapsulated ingredients, it is preferable that the one or more curing agents can cause the polymeric compounds to react at a temperature below about 250° C., more typically below about 200° C., more typically below about 180° C., or even below 150° C. It is possible that the rupture initiator avoids any activation at temperatures that the material will encounter during compounding and secondary processing such as injection molding, extrusion or the like. As such, it may be beneficial that the rupture agent does not activate at temperatures below 120° C. For example, the rupture agent may activate at temperatures at or above 140° C.

In addition to curing, the adhesive material may, optionally, also be activated to foam, and therefore, may include a blowing agent or, alternatively, the reaction of the polymeric components (which may include one of the curing agent or curing agent accelerator) with the curing agent and/or curing agent accelerator may liberate a gas for foaming or expanding the adhesive material. If used, the foaming or expansion of the adhesive material may be able to assist the adhesive material in wetting and/or adhering to members of a structure.

The encapsulated materials described herein may be utilized in epoxy-based systems, urethane-based systems, acrylate-based systems, or systems utilizing monomeric or oligomeric reactive compounds to create polymers. The materials may be adhesives, sealants, reinforcing materials, tapes, or some combination thereof. The materials may be pumpable or bulk dispensable (e.g., paste like products that are adapted to be dispensed via a pump). Generally, for polyurethane systems (e.g., systems with isocyanates and isocyanate-reactive compounds) various different combinations of components can provide for a system that only reacts or for a system that expands or foams and cures. For other systems (e.g., epoxy/amine, acrylate/amine, acrylate/peroxide or other systems), and even for polyurethane systems, an additional blowing agent (e.g., a physical or chemical blowing agent) may be needed or desired for foaming or expanding. Exemplary blowing agents can include one or more nitrogen containing groups such as amides, amines and the like, carbonates, or can be thermoplastic encapsulated solvents or other chemicals.

It is possible that the encapsulated component is a curing agent accelerator. The curing agent accelerator may be a urea-based curing agent accelerator. The curing agent accelerator may be encapsulated due to its tendency to cause an increase in viscosity over time via reaction acceleration following mixing with the remaining components of the material. Whereas the curing agent may have a reduced effect on the viscosity of the material. The urea-based curing agent accelerator may be a solid material at room temperature. The encapsulated curing agent accelerator may be exposed to the remaining components upon exposure of the encapsulating material to heat. It is possible that the curing agent utilized in conjunction with urea-based curing agent accelerator includes dicyandiamide (examples include Amicure CG1200G or DDA10). By encapsulating the curing agent accelerator, it is possible to reduce reaction activity while utilized in an extruder, injection molding machine, or other melt-processing equipment. Further, the shelf life of the material may be extended by two months, three months, four months, five months, or even six months.

It is also possible that the encapsulated component is a low temperature curing agent. For example, the encapsulated component may be selected from amines, imidazoles, mercaptans, or combinations thereof, in order to make low temperature reacting products. It is possible that these curing agents are liquid curing agents. It is possible that these curing agents are solid curing agents. In a preferred embodiment, the encapsulated material is a liquid material that is effectively maintained in a fully encapsulated form through compounding and secondary processing until exposed to sufficient heat.

The encapsulating material may protect or isolate the encapsulated components from initiating a reaction with the remainder of the components within the material and will upon exposure to or application of physical or chemical modification release some or all of the encapsulated component. The encapsulation material (e.g., encapsulate shell) may comprise a polymeric material which may be a crosslinked polymeric material. The encapsulating material may include polyester, gelatin, polyoxymethylene urea formaldehyde, melamine formaldehyde, polyurethane or silica.

The encapsulated material may be selected so that a large number of particles are included within the shell in an effort to disperse the particles throughout the polymeric matrix material. It is possible that large particle size reactive materials may not be selected as distribution of the reactive material within the polymeric matrix may become challenging when the number of particles are limited.

Formation of the materials described herein can be accomplished according to a variety of new or known techniques. Preferably, the adhesive material is formed as a material of substantially homogeneous composition. However, it is contemplated that various combining techniques may be used to increase or decrease the concentration of certain components in certain locations of the material.

It is possible that the adhesive material is formed by supplying the components of the material in solid form such as pellets, chunks, encapsulations and the like, in liquid form or a combination thereof. The components are typically combined in one or more containers such as large bins or other containers. Preferably, the containers can be used to intermix the components by rotating or otherwise moving the container or the material therein. Thereafter, heat, pressure or a combination thereof may be applied to soften or liquidize the components such that the components can be intermixed by stirring or otherwise into a single homogenous composition. When used, such heat and/or pressure are typically relatively low so as not to damage or rupture any encapsulations. Thus, it may be desirable for the non-encapsulated components of the material to have relatively low viscosities for allowing mixing under lower pressure and lower heat conditions. Thus, the component selected for encapsulation may be selected to avoid undesirable increases in viscosity.

The material may be formed by heating one or more of the components that is generally easier to soften or liquidize such as the polymer-based materials to induce those components into a mixable state. Thereafter, the remaining components may then be intermixed with the softened components.

The present teachings herein are predicated upon provision of an improved material (e.g., a curable material), and articles incorporating the same. The material may assist in providing structural reinforcement, adhesion, baffling, acoustical absorption, vibration damping properties or a combination thereof within a cavity of, or upon a surface of a structure, or to one or more structural members of an article of manufacture. The material may include any material that may be activated to melt, flow, cure (e.g., thermoset), expand, foam or a combination thereof by an ambient condition or another condition. For example, the material may expand, foam, flow, melt, cure, a combination thereof or the like upon exposure to a condition such as heat, pressure, chemical exposure, combinations thereof or the like. The encapsulating material may fail and release any material contained therein under similar conditions.

The material may include an elastomer-based compound. The elastomer compound may be a thermosetting elastomer, although not required. Exemplary elastomers include, without limitation, natural rubber, styrene-butadiene rubber, polyisoprene, polyisobutylene, polybutadiene, isoprene-butadiene copolymer, neoprene, nitrile rubber (e.g., a butyl nitrile, such as carboxy-terminated butyl nitrile), butyl rubber, polysulfide elastomer, acrylic elastomer, acrylonitrile elastomers, silicone rubber, polyester rubber, diisocyanate-linked condensation elastomer, EPDM (ethylene-propylene diene rubbers), and the like.

Generally, it is preferable for the activatable to include at least one type of polymeric particle. Such polymeric particles may be utilized to improve fracture toughness (G_{1C}), peel resistance and impact resistance. As used herein, like with any other ingredients of the present teachings, the term “polymeric particle” can include one or more polymeric particles.

The material may include a polymer, or other additive for increasing strength, strain to failure, and/or expansion properties. The additive may allow the material to have an improved balance between Young's modulus (as measured by ASTM D638) and strain to failure as compared to materials without the additive. For example, the additive may allow both modulus and strain to failure to be increased simultaneously as opposed to a material without the additive. After curing, the material may exhibit a tensile modulus of at least about 100 MPa, more typically at least about 200 MPa, and even more typically at least about 500 MPa. After curing, the material may exhibit a tensile modulus of about 1500 MPa or less, more typically about 1200 MPa or less, and even about 1000 MPa or less.

The material may include a flexibilizer. The use of the term flexibilizer can relate to a single flexibilizer or a combination of multiple different flexibilizers. Although other flexibilizers may be employed, preferred flexibilizers include polymers that are amine modified, epoxy modified, or both. These polymers can include thermoplastics, thermosets or elastomers, combinations thereof or the like. These polymers may be modified with aromatic or non-aromatic epoxy and/or may be modified with bisphenol-F type, bisphenol-A type, combinations thereof or other type epoxy. Examples of preferred flexibilizer are epoxidized polysulfides sold under the tradenames EPS-350 and EPS-80, commercially available from Akzo Nobel.

Phenol-containing molecules such as the flexibilizer Rez-Cure EP 1820 (available from Innovative Resin Systems) is one possible material that may be utilized. An example of another preferred flexibilizer is an epoxy-dimer acid elastomer sold under the tradenames HYPOX DA 323, commercially available from CVC Specialty Chemicals. An example of other preferred flexibilizers are polyurethane modified epoxies sold under the tradenames GME-3210 and GME-3220, commercially available from GNS Technologies. Without being bound by theory, it is believed that when a polyurethane modified epoxy flexibilizer is included the activatable material may substantially maintain impact strength (e.g., impact resistance) at low temperatures, while minimizing the reduction of glass transition temperature (Tg) (e.g., as compared to other flexibilizers). Yet further examples of preferred flexibilizer are amine or epoxy terminated polyethers such as JEFFAMINE D-2000, commercially available from Huntsman and DER 732, commercially available from the Dow Chemical Company. Flexibilizers based on cashew nutshell liquid such as the epoxidized liquids Cardolite NC-514 and Cardolite Lite 2513 HP are also useful flexibilizers. All of the individual flexibilizers discussed herein may be used separately or in combination with each other in the material of the present invention, unless otherwise stated.

One or more blowing agents may be added to the material for producing an open and/or closed cellular structure within the material. In this manner, it may be possible to modify the density of articles fabricated from the material as required for a particular application.

The blowing agent may include one or more nitrogen containing groups such as amides, amines and the like. Examples of suitable blowing agents include azodicarbonamide, dinitrosopentamethylenetetramine, 4,4ᵢ-oxy-bis-(benzenesulphonylhydrazide), trihydrazinotriazine and N,Nᵢ-dimethyl-N,Nᵢ-dinitrosoterephthalamide. The material may include a physical blowing agent, including but not limited to agents such as Expancel available from AkzoNobel.

An accelerator for the blowing agents may also be provided in the activatable material. Various accelerators may be used to increase the rate at which the blowing agents form inert gasses. One preferred blowing agent accelerator is a metal salt, or is an oxide, e.g. a metal oxide, such as zinc oxide. Other preferred accelerators include modified and unmodified thiazoles, ureas and imidazoles.

The present teachings also contemplate the omission of a blowing agent. Preferably, however, the material, the blowing agent or both of the present teachings are thermally activated. Alternatively, other agents may be employed for realizing activation by other means, such as moisture, radiation, or otherwise.

The material may include one or more additional polymers or copolymers, which can include a variety of different polymers, such as thermoplastics, elastomers, plastomers combinations thereof or the like. For example, and without limitation, polymers that might be appropriately incorporated include halogenated polymers, polycarbonates, polyketones, urethanes, polyesters, silanes, sulfones, allyls, olefins, styrenes, acrylates, methacrylates, epoxies, silicones, phenolics, rubbers, polyphenylene oxides, terphthalates, acetates (e.g., EVA), acrylates, methacrylates (e.g., ethylene methyl acrylate polymer) or mixtures thereof. Other potential polymeric materials may be or may include, without limitation, polyolefin (e.g., polyethylene, polypropylene) polystyrene, polyacrylate, poly(ethylene oxide), poly(ethyleneimine), polyester, polyurethane, polysiloxane, polyether, polyphosphazine, polyimide, polyimide, polyisobutylene, polyvinyl butyral, polyacrylonitrile, acrylonitrile butadiene styrene, poly(vinyl chloride), poly(methyl methacrylate), poly(vinyl acetate), poly(vinylidene chloride), polytetrafluoroethylene, polyisoprene, polyacrylamide, polyacrylic acid, polymethacrylate.

In certain embodiments, it may be desirable to include thermoplastic polyethers in the activatable material. As with the other materials, however, more or less thermoplastic polyether may be employed depending upon the intended use of the activatable material. The thermoplastic polyethers typically include pendant hydroxyl moieties. The thermoplastic polyethers may also include aromatic ether/amine repeating units in their backbones. The thermoplastic polyethers of the present teachings preferably have a melt index between about 5 and about 300, more preferably between about 30 and about 250 grams per 10 minutes for samples weighing 2.16 Kg at a temperature of about 190° C. Of course, the thermoplastic polyethers may have higher or lower melt indices depending upon their intended application. Preferred thermoplastic polyethers include, without limitation, polyetheramines, poly(amino ethers), copolymers of monoethanolamine and diglycidyl ether, combinations thereof or the like.

According to one embodiment, the thermoplastic polyether is formed by reacting a primary amine, a bis(secondary) diamine, a cyclic diamine, a combination thereof or the like (e.g., monoethanolamine) with a diglycidyl ether or by reacting an amine with an epoxy-functionalized poly(alkylene oxide) to form a poly(amino ether). According to another embodiment, the thermoplastic polyether is prepared by reacting a difunctional amine with a diglycidyl ether or diepoxy-functionalized poly(alkylene oxide) under conditions sufficient to cause the amine moieties to react with the epoxy moieties to form a polymer backbone having amine linkages, ether linkages and pendant hydroxyl moieties. Optionally, the polymer may be treated with a monofunctional nucleophile which may or may not be a primary or secondary amine.

Additionally, it is contemplated that amines (e.g., cyclic amines) with one reactive group (e.g., one reactive hydrogen) may be employed for forming the thermoplastic polyether. Advantageously, such amines may assist in controlling the molecular weight of the thermoplastic ether formed.

Examples of preferred thermoplastic polyethers and their methods of formation are disclosed in U.S. Pat. Nos. 5,275,853; 5,464,924 and 5,962,093, which are incorporated herein by reference for all purposes. Advantageously, the thermoplastic polyethers can provide the activatable material with various desirable characteristics such as desirable physical and chemical properties for a wide variety of applications as is further described herein.

Although not required, it is possible for the material to include one or more ethylene polymers or copolymers such as ethylene acrylates, ethylene acetates or the like. Ethylene methacrylate and ethylene vinyl acetate are two preferred ethylene copolymers. It is also possible that the material may be free of any ethylene polymers or copolymers.

It may also be desirable to include a reactive polyethylene resin that is modified with one or more reactive groups such as glycidyl methacrylate or maleic anhydride. Examples of such polyethylene resins are sold under the tradename LOTADER® (e.g., LOTADER AX 8900) and are commercially available from Arkema Group.

The activatable material may also include one or more reinforcement components. Preferably the reinforcement components include a material that is generally non-reactive with the other components present in the activatable material. It is contemplated that the reinforcement components may also impart properties such as strength and impact resistance to the activatable material.

Examples of reinforcement components include wollastonite, silica, diatomaceous earth, glass, clay (e.g., including nanoclay), glass beads or bubbles, glass, carbon or ceramic fibers, nylon, aramid or polyamide fibers, and the like. The one or more reinforcement components may be selected from mineral reinforcements such as diatomaceous earth, clay (e.g., including nanoclay), pyrophyllite, sauconite, saponite, nontronite, wollastonite, or montmorillonite. The reinforcement component may include a silica and/or calcium mineral reinforcement. The reinforcement component may include glass, glass beads or bubbles, carbon or ceramic fibers, nylon, aramid or polyamide fibers (e.g., Kevlar). The reinforcement component may be wollastonite. The reinforcement component may be a fiber with an aspect ratio of from about 20:1 to about 3:1. The reinforcement component may be a fiber with an aspect ratio of from about 15:1 to about 10:1. The reinforcement component may be a fiber with an aspect ratio of about 12:1. It is possible that the reinforcement component improves a first physical characteristic while simultaneously substantially avoiding any significant detrimental effect on a second physical characteristic. As one example, the selected reinforcement component may improve the overall modulus of the material while still having minimal detrimental on strain to failure. The material may further include one or more fillers including pigments or colorants, calcium carbonate, talc, silicate minerals, vermiculite, mica, or the like.

It is contemplated that most nearly any additional chemicals, materials or otherwise may be added to the activatable material assuming they are suitable for the activatable material and suitable for a chosen application of the activatable material.

Other additives, agents or performance modifiers may also be included in the activatable material as desired, including but not limited to a UV resistant agent, a flame retardant, a polymeric particle, a heat stabilizer, a colorant, a processing aid, a lubricant or the like.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of at “′x′ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for ail purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A material comprising:
i) an encapsulated component within a shell;
ii) a rupture initiator associated with the encapsulated component;
iii) a polymeric epoxy, ethylene, or methacrylate-based matrix material;
wherein the encapsulation is adapted to fail upon activation of the rupture initiator allowing the encapsulated component to be liberated to initiate a reaction or increase the reactivity of the material.

2. The material of claim 1, wherein the rupture initiator is inside the shell with the encapsulated component.

3. The material of claim 1, wherein the rupture initiator is formed as part of the shell surrounding the encapsulated component.

4. The material of claim 1, wherein the rupture initiator comprises a foaming agent.

5. The material of claim 1, wherein the encapsulated component comprises a plurality of particles to improve dispersion after liberation of the encapsulated component.

6. (canceled)

7. The material of claim 1, wherein the rupture initiator comprises a chemical or physical blowing agent.

8. The material of claim 1, wherein the encapsulated component is selected from a curing agent, curing agent accelerator, foaming agent, foaming agent activator, moisture scavenger, acid, monomer, odor scavenger, or any combination thereof.

9. The material of claim 8, wherein the rupture initiator activates in response to a stimulus.

10. The material of claim 8, wherein the rupture initiator activates in response to a stimulus selected from pressure, heat, ultraviolet light, moisture, or any combination thereof.

11. The material of claim 1, wherein the encapsulated component is a curing agent.

12. The material of claim 1, wherein the encapsulated component is a curing agent accelerator.

13. The material of claim 1, wherein the encapsulated component is liquid at room temperature (20° C.-22° C.).

14. The material of claim 1, wherein the encapsulated component is solid at room temperature (20° C.-22° C.).

15. The material of claim 1, wherein the encapsulated component is dicyandiamide or a urea-based agent.

16. The material of claim 1, wherein the encapsulated component is selected from amines, imidazoles, mercaptans, or combinations thereof.

17-20. (canceled)

21. The material of claim 8, wherein the encapsulated component is a curing agent that causes the polymeric matrix to react at a temperature below 250° C., below 190° C., or even below 140° C.

22. The material of claim 8, wherein the material is a thermoset material after cure.

23. The material of claim 8, wherein the material is a thermoplastic material.

24. The material of claim 1, wherein the material is a foamable material.

25-28. (canceled)

29. A method for forming an industrial material comprising:
encapsulating an encapsulated component in an encapsulate shell;
locating a rupture initiator within the encapsulate shell or within the shell surface;
mixing the encapsulated component with a polymeric epoxy, ethylene, or methacrylate-based matrix material;
activating of the rupture initiator to allow the encapsulated component to be liberated to initiate a reaction or increase the reactivity of the material.

30-59. (canceled)
